(19) United States
(12) Patent Application Publication
(10) Pub. No.: US 2022/0228740 A1
(43) Pub. Date: Jul. 21, 2022

(54) SUSTAINABLE CANDLES AND METHODS

(71) Applicant: Votivo, LLC, Spartanburg, SC (US)

(72) Inventors: Robert E. Caldwell, JR., Spartanburg, SC (US); Ricardo Obando, Spartanburg, SC (US)

(21) Appl. No.: 17/567,367

(22) Filed: Jan. 3, 2022

Related U.S. Application Data
(60) Provisional application No. 63/138,892, filed on Jan. 19, 2021.

(51) Int. Cl. F23D 3/18; C11C 5/00

(52) U.S. Cl. CPC F23D 3/18; C11C 5/008

(57) ABSTRACT

Disclosed are apparatuses and corresponding and/or associated methodologies for sustainable (refillable) candles. This technology relates to refurbishing a used candle jar or container, so that its depleted wick and/or wax components are exchanged for replacement wick and wax components, so that the candle jar can be reused instead of being thrown out. An end of the wick is associated with an anchor or insert (such as a centering or positioning heat-resistant disc, removable silicone (or other materials) tray, or other). The replacement wick is physically held straight up and held in place by replacement scented wax beads, pellets, or the like poured into the jar. Burning of the wick melts and consumes the wax as it goes. After the wax and wick are exhausted, the insert and any remaining wax and other debris are removed from the jar in preparation for another refurbishment cycle. The insert is cleaned as needed for reuse with a new replacement wick.

### PRIORITY CLAIM

This application claims the benefit of previously filed U.S. Provisional Patent application entitled “SUSTAINABLE CANDLES,” assigned U.S. Ser. No. 63/138,892, filed Jan. 19, 2021, and which is incorporated herein by reference for all purposes.

### FIELD OF THE SUBJECT MATTER

The presently disclosed subject matter generally relates to sustainable candles. Some embodiments may relate more particularly to apparatus/devices and corresponding and/or associated methodologies for refillable scented or unscented candles for diffusing fragrance and/or affecting ambiance relative to a selected environment, such as a room or area.

### BACKGROUND OF THE SUBJECT MATTER

In certain applications it is desirable to provide devices which are effective in fragrancing (or treating) or providing ambiance (whether scented or not) for an associated area, such as a room or meeting space, while also limiting interactions which might otherwise in any way cause adverse experiences.

Jar candles are one popular form of devices useful for providing scent in a selected area, or in some instances more of a primary treatment or conditioning aspect such as repellants. Some jar candle conventional practices can contribute to the creation of waste materials. For example, each scented jar candle requires a jar and often a lid which may be disposed of by consumers after use. Significant energy is required in the first instance by a manufacturing process to create glass. While glass can be recycled, many municipalities do not accept glass for recycling because the energy and effort required to sort and recycle glass is nonetheless greater than that required to manufacture glass from scratch. Still further, many glass products used for jar candles often comprise annealed glass which can be even more difficult/expensive to recycle. Accordingly, many glass products of any type simply wind up in a landfill.

The foregoing manufacturing and use cycle does not take into account all the energy and packaging required to transport glass in a sufficiently safe way to keep it from breaking. Also, glass is relatively heavy and bulky. Modern sourcing models may involve significant shipping distances, such as from an overseas manufacturing point to a domestic distribution chain which sees further shipping (and associated carbon emissions) in order to deliver the glass products to a customer or consumer. From a cost perspective, significant areas of the cost of a candle include the container (i.e., the jar itself), the lid, and all the packaging and freight related to shipping.

Some existing products require the application of external heat by the user/consumer to melt a source of wax into a liquid or at least more pliable form to facilitate its placement or transfer into a container such as a jar. Required use of such heat and/or melted products (even if only temporarily melted) requires additional energy and can create a risk of injury to the user.

Various types of candles and other subject matter are known. For example, various examples are disclosed in the patent literature, such as in U.S. Pat. Nos. 10,238,097; 7,731,492; 7,524,187; 7,229,280; 4,826,428; 4,427,366; and 3,741,711, and such as in US Published Applications Publication Nos. 2013/0029276A1; 20030162142A1; and 2002/0090585A1, and such as in Korean Published Application No. 2007/0013523A, the disclosures of all of which are fully incorporated herein by reference, and for all purposes.

While various implementations of jar candles have been developed, no design and associated practices have emerged that generally encompasses all of the desired characteristics as hereafter presented in accordance with the presently disclosed technology. Presently disclosed subject matter results in jar candle products (scented or unscented) which are much more sustainable and which also greatly increase and improve cost efficiencies while also improving ease of use by the consumer and safety of the user.

### SUMMARY OF THE SUBJECT MATTER

In view of the recognized features encountered in the prior art and addressed by the presently disclosed subject matter, improved apparatus/devices and corresponding and/or associated methodologies therefor have been provided for improved practices in conjunction with fragrance diffusion. More particularly, the presently disclosed subject matter relates to refurbishing a used candle jar (or other form of vessel), so that its depleted and/or consumed wick and/or wax components are exchanged for replacement wick and wax, so that the candle jar can be reused instead of being thrown out.

One presently disclosed exemplary embodiment relates to scented or unscented jar candle devices that are fitted for reuse with a replacement wick and wax beads by threading an end of the wick through a component such as an accompanying centering disc, and then placing the disc into the empty jar. Whether scented or unscented, the subject candles may in some instances be used in conjunction with adding to the ambiance of a space. The replacement wick may be physically held at least mostly straight up while replacement scented (or unscented) wax beads are poured into the jar. Once placed, the beads continue to hold the wick in a centered position. Burning of the wick melts (and consumes) the wax as it goes. The entire bottom piece may be lifted out and replaced and/or cleaned for reuse after the wax and/or wick are exhausted, or other relative motion between the jar and the debris otherwise created, which removes any remaining wax at the bottom of the jar in preparation for another refurbishment cycle. The centering disc or device is retrieved by generating relative movement between the bottom of the candle container and remaining wax to facilitate removal of the remaining wax, wick and/or other debris from the candle container and centering disc, so the candle container and centering disc can be reused.

In yet further exemplary embodiments, the presently disclosed technology and subject matter for refurbishing a used candle allows a same piece of glass (or container of other material) to be re-used potentially hundreds of times by the consumer.

In some instances, presently disclosed exemplary embodiments may make use of fragranced wax beads, pellets, and/or flakes or other shapes (including chunks) of fragranced (or non-fragranced) wax that can be packaged in a recyclable paper pouch. Included in a pouch could be a wick appropriately sized for a corresponding preexisting jar and/or a particular wax formulation and/or fragrance and/or color, to ensure a clean and/or best possible burn. Likewise, a corresponding pouched amount of beads can be sized for a single refilling use of a particular, corresponding jar product. In some instances, the subject pouch may hold materials sufficient for plural corresponding jar products or for multiple reuses of a given vessel.

One presently disclosed exemplary embodiment relates to a sustainable candle, comprising a candle container which is cleanable after use thereof to remove any debris therein; an anchoring component associated with such candle container; an elongated replacement wick having an anchor end thereof secured to such anchoring component, and having an unassociated free end thereof, positioned generally above such anchor end, for being selectively lighted for burning the replacement wick; and replacement wax elements received in such candle container while such wick anchor end is secured to such anchoring component, whereby replacement wick and wax elements may be received in a used candle container once cleaned.

Another presently disclosed exemplary embodiment relates to a sustainable candle kit for use with a reusable candle container, comprising an elongated replacement wick having a first end thereof and having an unassociated free second end thereof for being selectively lighted for burning the replacement wick; and at least one replacement wax element receivable in such candle container while such wick first end is received in such at least one replacement wax element, whereby replacement wick and wax elements are refillable with the cleaned previously used candle container so that the candle container can be reused instead of being thrown out.

The presently disclosed subject matter relates to both apparatus/devices as well as corresponding and/or associated methodologies. Likewise, the presently disclosed subject matter equally relates to scented or unscented candles, regardless of whether such alternative is expressed in each and every sentence of the subject application.

One exemplary embodiment of presently disclosed subject matter relates to methodology for providing sustainable candles by refurbishing a used candle container for reuse thereof, comprising cleaning out a used candle container to remove any debris therein; associating one end of a replacement wick with an anchoring component associated with the candle container; directing an unassociated free end of the replacement wick into a generally upward position relatively away from walls of the used candle container; and placing replacement wax elements into the used candle container, whereby any remaining prior wick and wax components in the used candle container are exchanged for replacement wick and wax components, so that the used candle container can be reused instead of being thrown out.

Yet another presently disclosed exemplary method relates to a method for using refillable candle jars for refurbishing a used candle jar so that its depleted wick and wax components are exchanged for replacement wick and wax, so that the candle jar can be reused instead of being discarded, comprising fitting a cleaned out candle jar with a replacement wick and wax beads by threading an end of the wick through an anchor component, and then placing the anchor component into the empty jar; and holding the replacement wick physically straight up while introducing replacement wax beads into the jar so that the beads continue to hold the wick in a designated position.

Additional objects and advantages of the presently disclosed subject matter are set forth in, or will be apparent to those of ordinary skill in the art from, the detailed description herein. Also, it should be further appreciated that modifications and variations to the specifically illustrated, referenced, and discussed features, elements, and steps hereof may be practiced in various embodiments and uses of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Additional embodiments of the presently disclosed subject matter may also include different combinations of features illustrated in various of the presently disclosed Figures and/or features beyond the exemplary features represented in such Figures. Those of ordinary skill in the art will better appreciate the features and aspects of such embodiments, and others, upon review of the remainder of the specification.

### BRIEF DESCRIPTION OF THE DRAWINGS

A full and enabling disclosure of the presently disclosed subject matter, including the best mode thereof, directed to one of ordinary skill in the art, is set forth in the specification, which makes reference to the appended figures, in which:

FIGS. 1A and 1B illustrate a generally isometric view and generally top perspective view, respectively, of one exemplary component of one exemplary embodiment of a sustainable candle product, for use per presently disclosed subject matter;

FIGS. 1C and 1D illustrate generally top perspective views of another exemplary embodiment of an exemplary component of an exemplary embodiment of a sustainable candle product, for use per presently disclosed subject matter;

FIGS. 2A through 2E illustrate generally bottom or top perspective views of still another exemplary embodiment of an exemplary component of an exemplary embodiment of a sustainable candle product, for use per presently disclosed subject matter;

FIGS. 2F through 2J illustrate generally bottom or top perspective views of yet another exemplary embodiment of an exemplary component of an exemplary embodiment of a sustainable candle product, for use per presently disclosed subject matter;

FIG. 3A illustrates a generally top perspective view of various presently exemplary disclosed components received in an exemplary reusable jar for a jar candle;

FIGS. 3B and 3C illustrate generally top and bottom perspective views, respectively, of exemplary components also in part represented by FIGS. 1A and 1B of presently disclosed subject matter relating to exemplary embodiments thereof;

FIGS. 3D and 3E illustrate generally side and top perspective views, respectively, of exemplary components also in part represented by FIGS. 1C and 1D of presently disclosed subject matter relating to exemplary embodiments thereof;

FIG. 4A illustrates a generally top, partial perspective view, representing various presently disclosed exemplary components also in part represented by FIGS. 3B and 3C, received in an exemplary reusable jar for a jar candle;

FIG. 4B illustrates a generally top, partial perspective view, representing various presently disclosed exemplary components also in part represented by FIGS. 3D and 3E, received in an exemplary reusable jar for a jar candle;

FIG. 4C illustrates a generally front perspective view of an exemplary embodiment of a pouch (in closed condition) for use in accordance with presently disclosed subject matter;

FIG. 4D illustrates a generally top perspective view of an exemplary embodiment of a pouch (in open condition) for use in accordance with presently disclosed subject matter, and representing exemplary components received in such pouch;

FIG. 5 illustrates a top perspective view of various presently disclosed exemplary components received in an exemplary reusable jar for a jar candle;

FIG. 6 is a representative flow chart (in continuous/loop form) of one exemplary embodiment of methodology in accordance with presently disclosed subject matter, including a recycle aspect thereof;

FIG. 7 is a representative flow chart (in linear form) of one exemplary embodiment of methodology in accordance with presently disclosed subject matter, including a reclaim aspect thereof;

FIG. 8 is a representative flow chart (in linear form) of one exemplary embodiment of methodology in accordance with presently disclosed subject matter, including a reload aspect thereof;

FIG. 9A is another representative flow chart (in continuous/loop form) of an exemplary embodiment of methodology in accordance with presently disclosed subject matter, including exemplary diagrammatic illustrations at various steps thereof;

FIG. 9B illustrates a generally top perspective view of an exemplary embodiment of presently disclosed subject matter ready for processing at the “Clean Out” step of application FIG. 9A;

FIG. 9C illustrates a generally top perspective view of an exemplary embodiment of presently disclosed subject matter ready for processing at the “Burn” step of application FIG. 9A;

FIG. 10A illustrates a generally side and upper perspective view of an exemplary embodiment of a cleanout tray or insert of presently disclosed subject matter;

FIG. 10B illustrates a generally side and upper perspective view of the exemplary embodiment of a cleanout tray or insert of presently disclosed subject matter as shown in FIG. 10A, further combined with presently disclosed replacement wick and related features;

FIG. 10C illustrates a generally side and lower perspective view of a further exemplary embodiment of a cleanout tray or insert of presently disclosed subject matter, also further combined with presently disclosed replacement wick and related features as in present exemplary FIG. 10B;

FIG. 10D illustrates a generally top and partial side perspective view of the further exemplary embodiment of a cleanout tray or insert of presently disclosed subject matter as in present exemplary FIG. 10C, and combined with presently disclosed replacement wick and related features as in present exemplary FIG. 10C;

FIG. 10E illustrates a generally bottom and partial side perspective view of the further exemplary embodiment of a cleanout tray or insert of presently disclosed subject matter as in present exemplary FIG. 10C, and combined with presently disclosed replacement wick and related features as in present exemplary FIG. 10C;

FIG. 10F illustrates a generally top and side perspective view of the exemplary subject matter of present FIG. 10B, further combined with a representative candle jar or container receiving the same;

FIG. 10G illustrates a generally top and side perspective view of the exemplary subject matter of present FIG. 10C, further combined with a representative candle jar or container receiving the same; and

FIG. 10H illustrates generally side and partial top perspective view of the exemplary subject matter of present FIG. 10B, being removed by a user from a representative candle jar or container as illustrated in FIG. 10F.

Repeat use of reference characters throughout the present specification and appended drawings is intended to represent same or analogous features, elements, or steps of the presently disclosed subject matter.

### DETAILED DESCRIPTION OF THE PREFERRED EMBODIMENTS

As discussed in the Summary of the Subject Matter section, the presently disclosed subject matter is generally concerned with apparatuses and methodologies relating to sustainable candles for fragrances and more particularly to apparatuses/devices and corresponding and/or associated methodologies for refillable scented candles for diffusing fragrance as desired into an ambient environment, such as a room or area.

Selected combinations of aspects of the presently disclosed technology correspond to a plurality of different embodiments of the presently disclosed subject matter. It should be noted that each of the exemplary embodiments presented and discussed herein should not insinuate limitations of the presently disclosed subject matter. Features or steps illustrated or described as part of one embodiment may be used in combination with aspects of one or more other embodiments to yield yet further embodiments. Additionally, certain features may be interchanged with similar devices or features not expressly mentioned which perform the same or similar function or functions.

Reference will now be made in detail to the presently preferred exemplary embodiments of the subject apparatus and associated and/or related methodology.

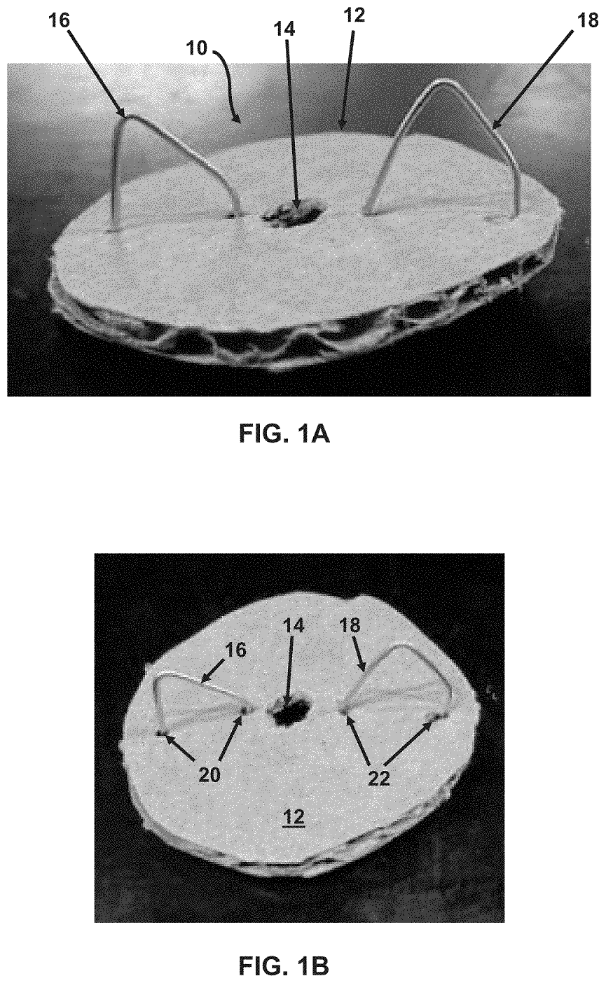

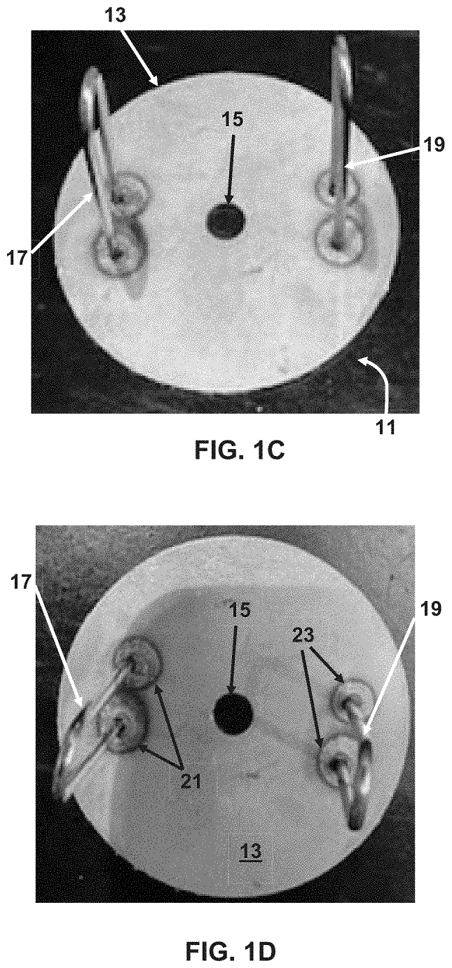

FIGS. 1A and 1B illustrate a generally isometric view and generally top perspective view, respectively, of an exemplary component generally 10 of one exemplary embodiment of a sustainable candle product, for use per presently disclosed subject matter. Such exemplary component 10 may comprise a centering disc having a main body generally 12 and a central through-opening or hole generally 14. A pair of handles 16 and 18 may be provided on respective opposite sides of through-hole 14. Particularly as shown in FIG. 1B, the respective exemplary handles may join at or through disc body 12 at plural locations 20 and 22 thereof, respectively.

Representations of FIGS. 1A and 1B (and elsewhere per this disclosure) show a mock-up main body 12 such as made of cardboard. For actual embodiments, a metal main body 12 (or other heat/fire resistant materials such as ceramics, or certain types of plastics, or alloys) may be practiced. Likewise, exemplary handles 16 and 18 (if used) are preferably heat/fire resistant, and may be joined to or integral with disc main body 12. Further, such handles may comprise any number such as zero or above, and situated in different locations about body 12. Having at least two handle members on generally opposite sides of through-hole 14 are advantageous for manipulation of body 12, as otherwise described herein. At the same time, alternative arrangements can be practiced, without having handles per se, and whereby body 12 is nonetheless adapted to be manipulated to generate relative movement between the bottom of the candle container and remaining wax to facilitate removal of such remaining wax and/or other debris from a candle jar or similar, as otherwise described herein.

FIGS. 1C and 1D illustrate an exemplary alternative arrangement, showing generally top perspective views of another exemplary embodiment of an exemplary component of an exemplary embodiment of a sustainable candle product, for use per presently disclosed subject matter.

In particular, representations of FIGS. 1C and 1D show a metal main body 13 (which could be other heat/fire resistant materials such as ceramics, or certain types of plastics, or alloys) which may be practiced. Likewise, exemplary handles 17 and 19 (if used) are preferably heat/fire resistant, and may be joined to or integral with disc main body 13. The pair of handles 17 and 19 may be provided on respective opposite sides of through-hole 15. Particularly as shown in FIG. 1D, the respective exemplary handles 17/19 may join at or through disc body 13 at plural locations 21 and 23 thereof, respectively.

Further, as in the earlier embodiment, such handles may comprise any number such as zero or above, and situated in different locations about body 13. Having at least two handle members on generally opposite sides of through-hole 15 are advantageous for manipulation of body 13, as otherwise described herein. At the same time, alternative arrangements can be practiced, without having handles per se, and whereby body 13 is nonetheless adapted to be manipulated as needed to generate relative movement between the bottom of the candle container and remaining wax to facilitate removal of such remaining wax and/or other debris from a candle jar or similar, as otherwise described herein.

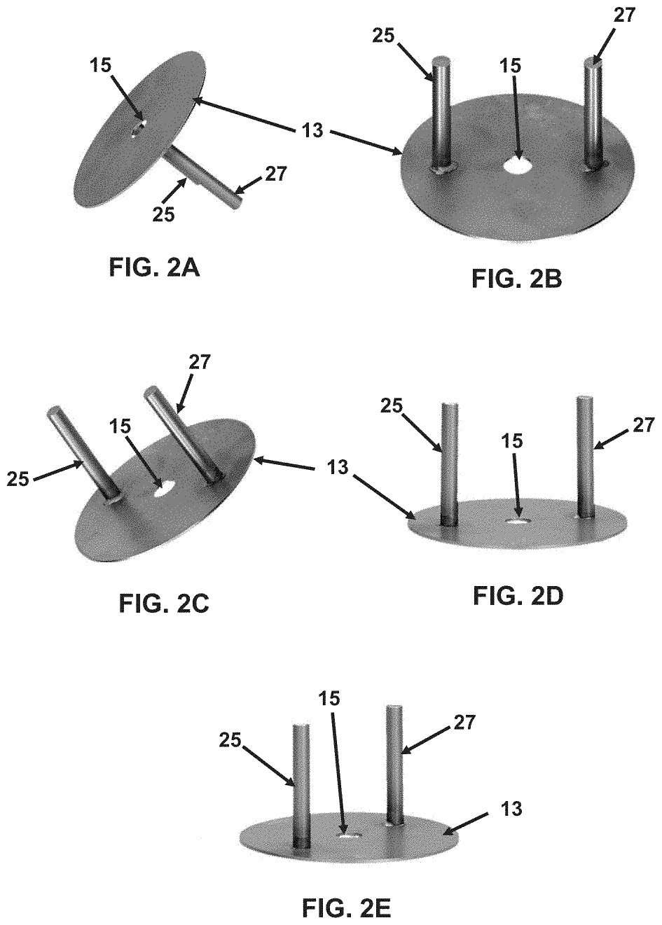

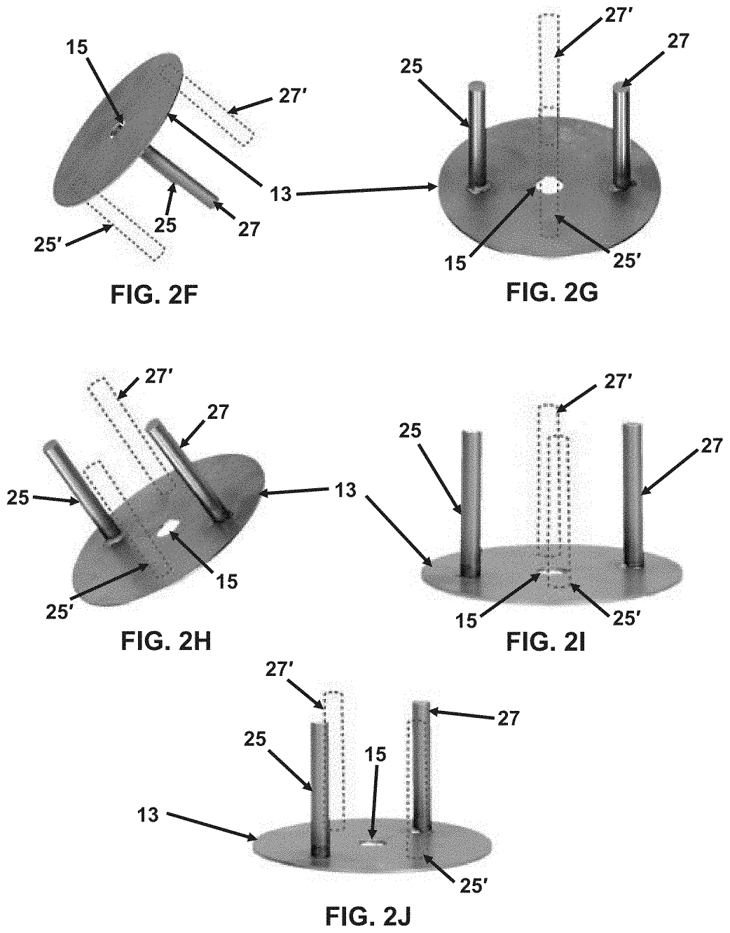

FIGS. 2A through 2E illustrate generally perspective views of still another exemplary embodiment of an exemplary component of an exemplary embodiment of a sustainable candle product, for use per presently disclosed subject matter. In particular, FIG. 2A illustrates a generally bottom perspective view of such exemplary subject matter while FIGS. 2B through 2E illustrate various top perspective views thereof.

FIGS. 2F through 2J illustrate generally perspective views of yet another exemplary embodiment of an exemplary component of an exemplary embodiment of a sustainable candle product, for use per presently disclosed subject matter. In particular, FIG. 2F illustrates a generally bottom perspective view of such exemplary subject matter while FIGS. 2G through 2J illustrate various top perspective views thereof.

While FIGS. 1C and 1D illustrate alternative features which illustrate, for example, further handle configurations which may be practiced, FIGS. 2A through 2J variously represent that different types or shapes of handles may be practiced as well as different numbers of handles. Each represented centering and clean out disc generally 13 may still be provided with a representative center hole or opening 15. As shown in FIGS. 2A through 2E, a pair of individual projections or handles 25 and 27 may be provided at various positions about center hole 15. The illustrated exemplary single respective handles 25 and 27 may be on generally opposite sides of such center hole 15 for improved mechanical leverage relative to movement of disc 15 in relation to the bottom of an associated jar or container. At the same time, other placements, including those not equidistant from each other or from opening 15, may be practiced in accordance with presently disclosed subject matter.

In addition to such exemplary handles 25 and 27, FIGS. 2F through 2J illustrate an additional set of handles 25′ and 27′ which may be provided. Images of the representative exemplary additional set of handles 25′ and 27′ in FIGS. 2F through 2J are shown in dotted line to represent that they may be optionally included, and that they may be variously placed on an upwardly facing surface (FIGS. 2G through 2J) of disc 13. Further, disc 13 may be formed of various materials, with cast aluminum being just one example. As shown, such handles 25 and 27, and handles 25′ and 27′ may be variously attached to disc 13, such as by metallurgical type processes (soldering, welding, brazing, or other processes now or later known), or other forms of attachment such as gluing. All such alternative attachment technologies, and numbers (higher or lower) of handles, shapes (single or multi-piece) of handles, and placement (equi-distant or not) of handles are intended to come within the spirit and scope of the present disclosure.

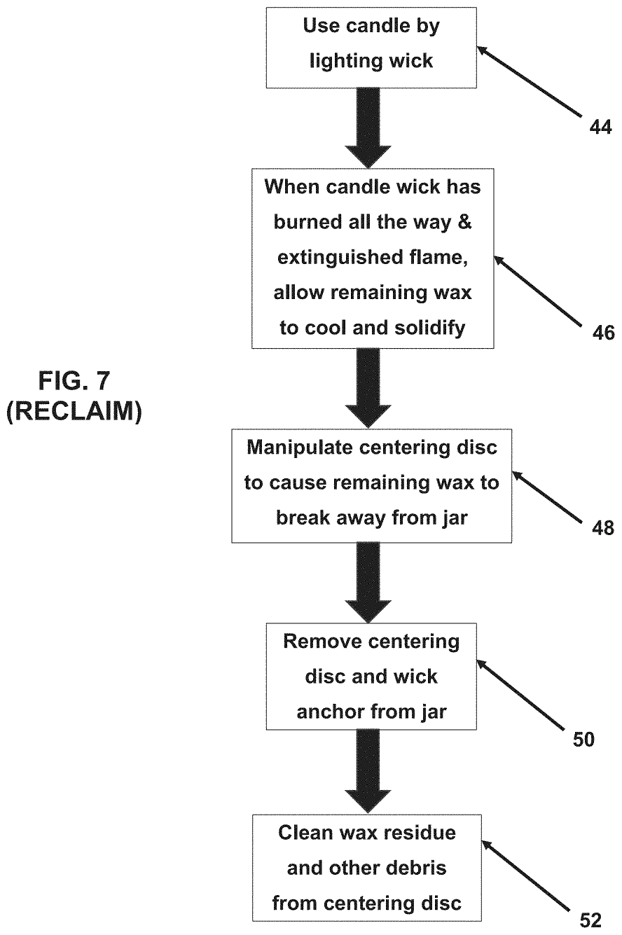

Another aspect of the presently disclosed subject matter relates to the ability and function of the disc 13 to facilitate removal of excess or remaining wax from an associated container. While cooling such remaining wax after a use may be part of a cycle of use (see other discussion herein including for example step 46 of FIG. 7), it should be understood that such cooling may be allowed to occur naturally (i.e. due do exposure in an existing environment), or may be accelerated (such as by use of a refrigerator or freezer). When accelerated, it is particularly useful to have a plurality of handle elements because the environmental interaction (such as by conduction of heat via metal components) can induce cracks into remaining wax, which facilitates loosening and removal of the wax. In general, such freezer-cracking aspect can be relatively improved by higher numbers of handles or respective handle elements. It should also be understood from the complete disclosure herewith that more generally speaking, it is the relative movement between the disc and the bottom of the receptacle (and whether large or small in scope) which contributes to such loosening and facilitated removal of wax in accordance with presently disclosed subject matter.

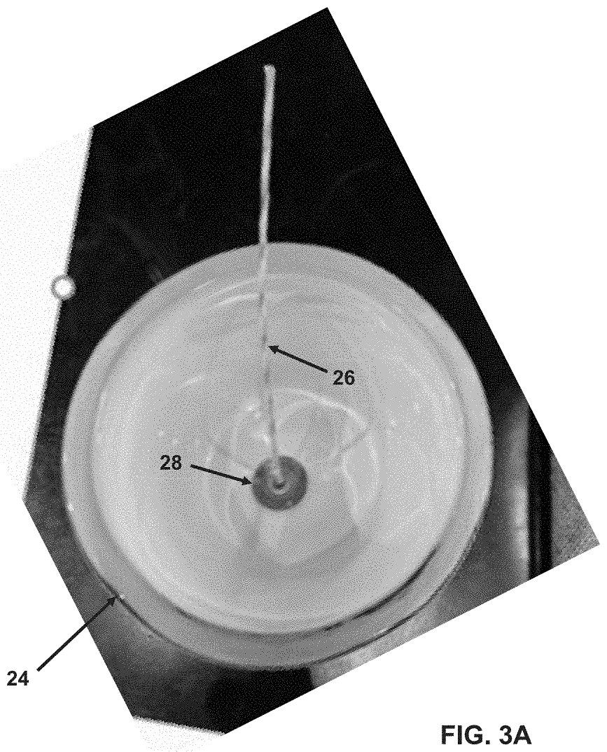

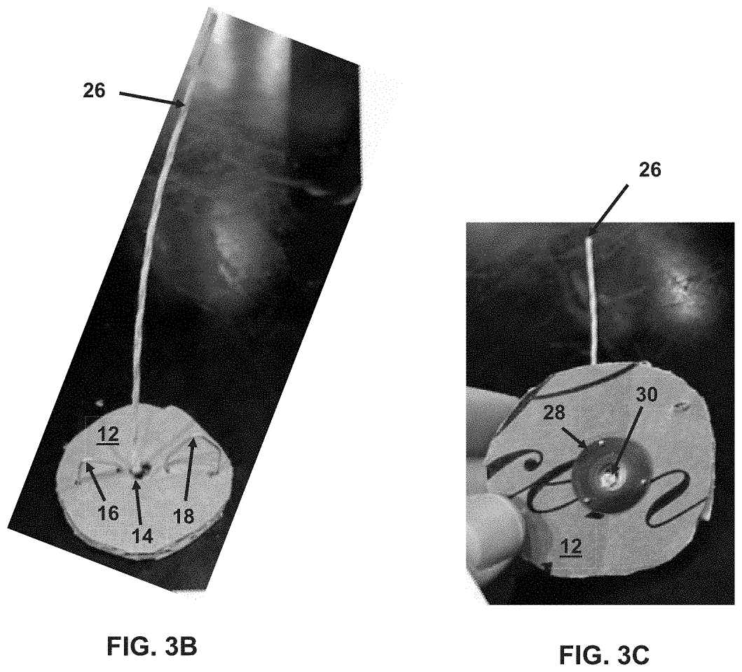

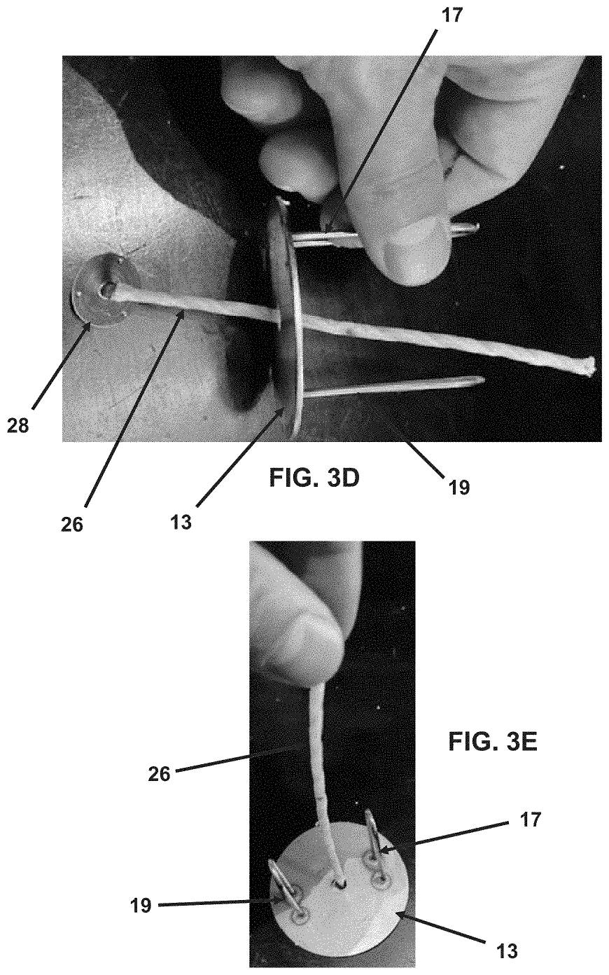

FIG. 3A illustrates a generally top perspective view of various presently disclosed components received in an exemplary reusable jar generally 24 for a jar candle. A representative exemplary votive-style candle jar 24 is shown but other shapes and sizes may be practiced. As will be understood by those of ordinary skill in the art will understand from the complete disclosure herewith, the size and shape of main body 12 of centering disc 10 is preferably matched to the bottom of an associated (or matched) jar 24. For example, body 12 may in some instances be round whenever a votive-style jar 24 is used. If the bottom of the jar is some other shape (such as rectangular or oval), then body 12 may be matched with it, both as to shape and size.

FIG. 3A further illustrates an exemplary replacement wick generally 26 associated with an anchor piece generally 28 and received in exemplary jar 24. FIG. 3A illustrates a desired location such as centered in the body of jar 24. Various techniques may be practiced for associating such anchor piece 28 with its associated wick 26. In its simplest form, anchor 28 may simply have a hole through which an end of wick 26 passes, with such as a knot then tied in such end of wick 26 so that it cannot be pulled back through the anchor. Any other mechanism for securing such end of wick 26 (for example, such as using a clip or crimping the anchor around the wick) may be practiced in accordance with the presently disclosed subject matter.

Further, more than one wick may in some instances be practiced with a refurbished candle. In such instance, the “centering” disc of the presently disclosed subject matter is more generally practiced as a “positioning” disc, so that the wicks are properly positioned for a clean burn and for safety (in terms of establishing separation from jar sidewalls and from adjacent wicks).

In addition to the multi-wick alternative referenced, the jar 24 does not have to be made of glass, but may be made of other materials (such as ceramics or metal or similar) which are capable of use adjacent to or in/part of a heated environment. This means that the practitioner of the presently disclosed subject matter can (under proper circumstances) potentially make use of alternative and/or repurposed objects, such as ceramic mugs. As will be understood by one of ordinary skill from the complete disclosure herewith, the size and shape of disc body 12 preferably should be selected and/or controlled to appropriately match the vessel with which it is used for most effective practices.

FIGS. 3B and 3C illustrate generally top and bottom perspective views, respectively, of representative components of presently disclosed subject matter relating to exemplary embodiments thereof. In particular, representative replacement wick 26 is shown as threaded through central hole 14 of disc main body 12, up to the point that the anchor 28 of wick 26 is situated against the bottom of disc body 12 (see FIG. 3C). Generally speaking, handles 16 and 18 protrude from a side of disc body 12 that is intended to be face up (relative to gravity) during use of jar 24 (see FIG. 3B), so the opposite side of disc body 12 comprises its bottom side. The illustrations of FIGS. 3B and 3C again are shown with a prototype fashioned from temporary materials, and which are not a perfect circular shape. If the centering disc is being used with a round jar 24, then the disc main body 12 would also be rounded to match, as will be understood by those of ordinary skill in the art. The presently disclosed subject matter is intended to be manually handled by a user, as represented by FIG. 3C. As further represented by FIG. 3C, the end of wick 26 associated with the anchor 28 (when used) may include a sustainer 30 or other element which is attached or crimped to wick 26 to prevent the wick from being drawn through the anchor. In some instances, a sustainer 30 may be omitted and any other form of attachment now known or later adapted may be used for positioning of wick 26.

Still further, it should be understood from the complete disclosure herewith that such anchor 28 and/or disc 12 (or other similar elements) may in some instances be disposable or recyclable rather than reusable. Also, a main body (or in some cases, disc) generally 12 may in some instances be omitted, and the anchor 28 (if used) instead directly used for assisting with cleaning out a depleted candle container. In some such instances, the anchor (if used) may be outfitted with one or more handles or other mechanisms for manipulation relative to the bottom of the candle container. In other words, again relative movement is generated between the bottom of the candle container and remaining wax, to facilitate removal of such remaining wax and/or other debris. That is to say that cleaning out a used candle container to remove any debris therein includes creating relative movement between the debris and the bottom of the candle container.

FIGS. 3D and 3E illustrate generally side and top perspective views, respectively, of exemplary components also in part represented by FIGS. 1C and 1D of presently disclosed subject matter relating to exemplary embodiments thereof. In particular, representative replacement wick 26 is shown as threaded through central hole 15 of disc main body 13, up to the point that the anchor 28 of wick 26 is situated against the bottom of disc body 13 (see FIG. 3D). Generally speaking, handles 17 and 19 protrude from a side of disc body 13 that is intended to be face up (relative to gravity) during use of jar 24 (see FIG. 3E), so the opposite side of disc body 13 comprises its bottom side. If the centering disc is being used with a round jar 24, then the disc main body 13 would preferably also be rounded to match, as will be understood by those of ordinary skill in the art. The presently disclosed subject matter is intended to be manually handled by a user, as represented by FIGS. 3D and 3E.

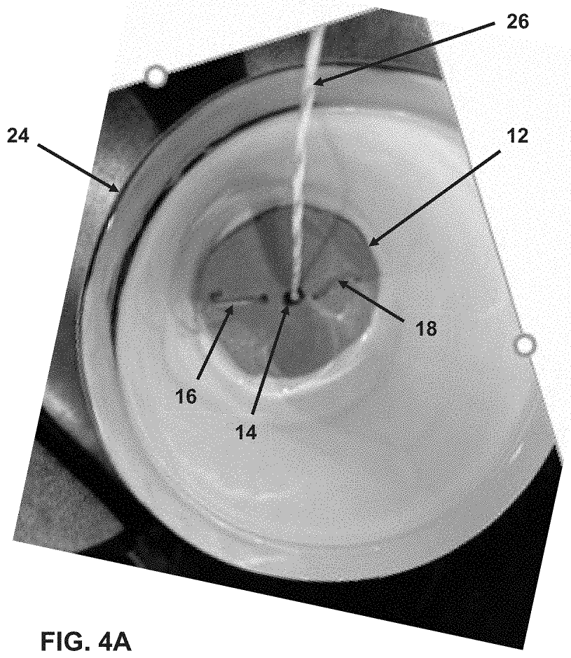

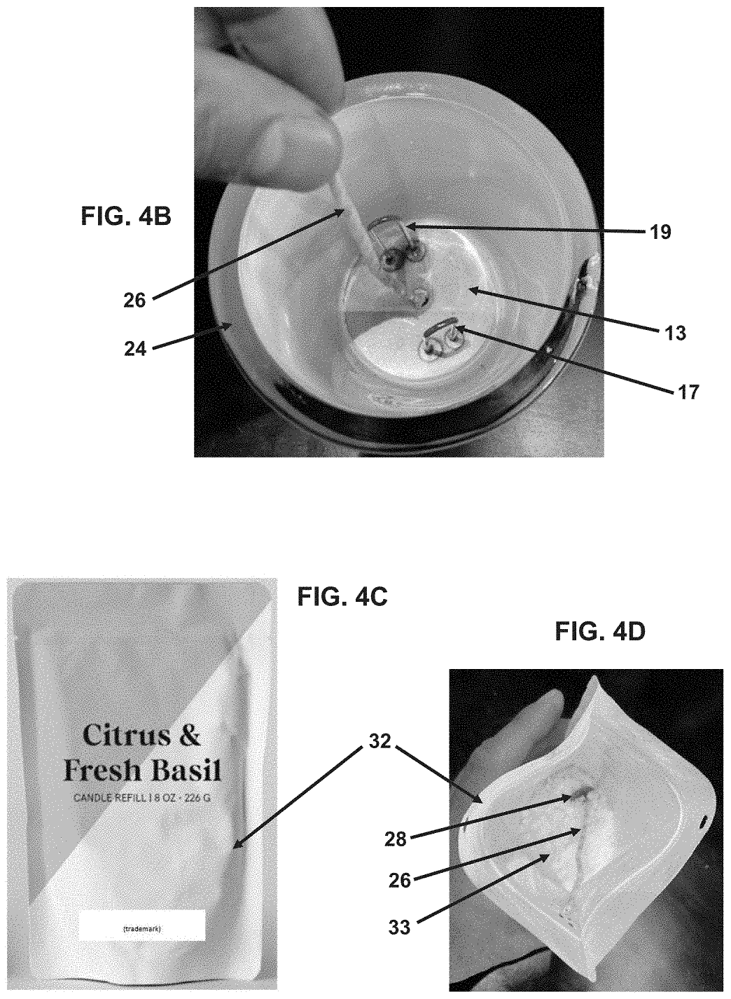

The presently disclosed exemplary centering disc subject matter serves multiple purposes. FIG. 4A illustrates a generally top, partial perspective view, representing various exemplary presently disclosed components received in an exemplary reusable jar 24 for a jar candle. In particular, circular disc main body 12 is received in the matching sized and circular-shaped bottom of jar 24, with handles exemplary 16 and 18 thereof facing upward, and wick 26 pointing upward. A significant risk of jar candles comes from the potential for a fire from uncentered (or otherwise poorly positioned) wicks. When a wick is off center (or otherwise poorly positioned), there is the potential for the flame(s) to come in contact or near contact with the glass (or ceramic), and for the glass/vessel to break, creating the potential for a fire or for consumer injury from glass shards, not to mention property damage from molten wax or from burning.

In conventional filled candle manufacturing operations, the candle manufacturer is able to put controls in place to insure that the wick is centered and secured to the bottom of the jar, often using automated equipment to center and glue the wick in place to keep it from “floating” into an off-centered position before the molten wax has solidified. Alternatively, some candle manufacturing operations rely upon wicks that can use a double-sided tape/glue tab that can be affixed to the bottom of the wick anchoring system, allowing the wick to be hand-placed and “glued” in the center of the container. Per presently disclosed subject matter, the size and shape of centering disc body 12 can be designed in a variety of shapes each of which are generally equal to the circumference of the inside of the associated candle jar 24 for intended use, thereby always being centered when placed in the bottom of the jar. Because the manufacturer and/or marketer for the refill wax and wick will no longer have control over the centering (positioning) of the wick in the candle jar, it is critically important for consumer safety liability reasons that there be a “fool-proof” method (provided by the centering/positioning disc) that enables the consumer to effectively secure the wick in a determined location of the reusable jar during preparation of the jar for reuse. For single wick arrangements, such determined location would typically be the center of the reusable jar. Locations other than the center may be practiced in some embodiments, as otherwise described herein.

Since disc body 12 has hole 14 in its center, and the wick is threaded through the hole, this ensures the wick is always centered in the bottom of the jar, and does not require any sort of glue or adhesive to keep it in the middle. Because the jar is re-wicked (and also re-filled) after each use, it is advantageous that the wick does not have to be adhered to the bottom of the jar (per presently disclosed subject matter), or otherwise removal of the remaining wick and its anchor would be very difficult. In some embodiments, it might be desirable to secure the wick anchor to the disc through either a magnet, or some other sort of clip mechanism so that both are easily retrieved together.

The two (preferably metal or similar) exemplary handles 16 and 18 (when used) may protrude upward out of the top of the disc body 12 on opposite sides of hole 14, with wick 26 in the center (see FIG. 4A). A frustrating part of attempted reusing of any jar candle can be cleaning out the remaining wax residue inside the bottom of the jar before inserting a new wick and refilling the container for the next use. Exemplary handles 16 and 18 on disc body 12 allow a consumer to easily generate relative movement between the bottom of the candle container and remaining wax by twisting the disc and holding it to remove the disc body 12, the anchor 28 and any remaining wick 26, along with any remaining wax on top of body 12, to remove all of it manually from jar 24. Thus, simple clean out is facilitated by the presently disclosed subject matter.

Once the disc is removed from the jar/container, any remaining wax is easily removed from the disc main body 12. A free end of a new (replacement) wick 26 is inserted through center 14 of disc body 12, which is then placed into the container (jar 24), and the container re-filled with wax beads (or pellets, etc.), all in accordance with presently disclosed subject matter. Unless otherwise indicated, the term “beads” herein is intended to refer broadly and generally to all possible conditions, shapes, or presentations of replacement wax.

FIG. 4B illustrates a generally top, partial perspective view, representing various presently disclosed exemplary components also in part represented by FIGS. 3D and 3E, received in an exemplary reusable jar for a jar candle. The two (preferably metal or similar) exemplary handles 17 and 19 (when used) may protrude upward out of the top of the disc body 13 on opposite sides of hole 15, with wick 26 in the center. A frustrating part of attempted reusing of any jar candle can be cleaning out the remaining wax residue inside the bottom of the jar before inserting a new wick and refilling the container for the next use. Exemplary handles 17 and 19 on disc body 13 allow a consumer to easily generate relative movement between the bottom of the candle container and remaining wax by twisting the disc and holding it to remove the disc body 13, the anchor 28 and any remaining wick 26, along with any remaining wax on top of body 13, to remove all of it manually from jar 24. Thus, simple clean out is facilitated by the presently disclosed subject matter.

FIG. 4C illustrates a generally front perspective view of an exemplary embodiment of a pouch 32 (in closed condition) for use in accordance with presently disclosed subject matter. As will be understood by those of ordinary skill in the art, a pouch design may be used which provides a top portion which may be manually ripped open by the consumer, or otherwise removed/opened such as cutting with use of scissors.

FIG. 4D illustrates a generally top perspective view of an exemplary embodiment of a pouch 32 (in open condition) for use in accordance with presently disclosed subject matter, and representing exemplary components received in such pouch. As represented, pouch 32 may hold a replacement wick 26 together with an anchor 28 or similar. Wick 26 and anchor 28 may reside loosely in pouch 32 and be removed by the user, after which wax elements 33 (such as shredded fragrance wax or some other shaped similar elements) may be used in presently disclosed methodology.

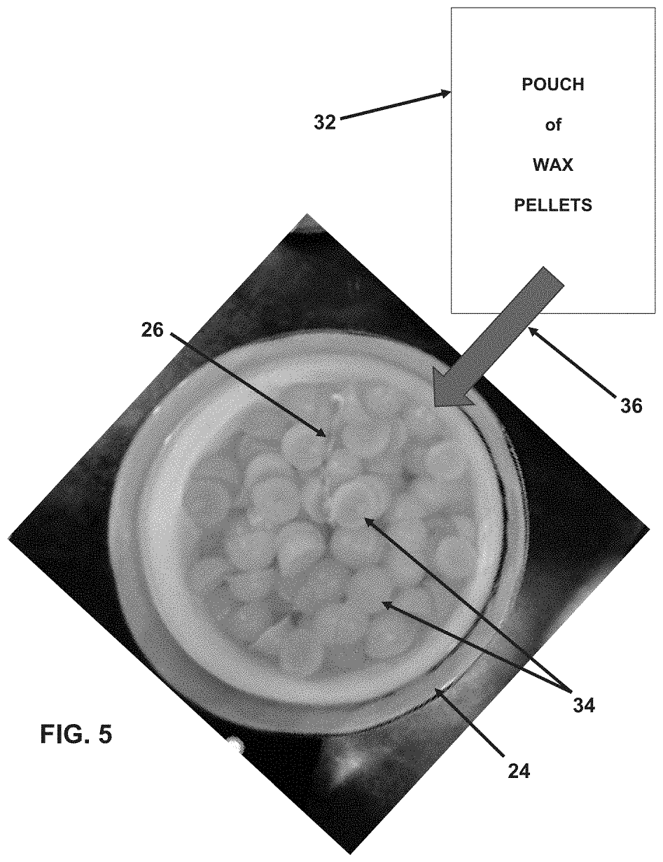

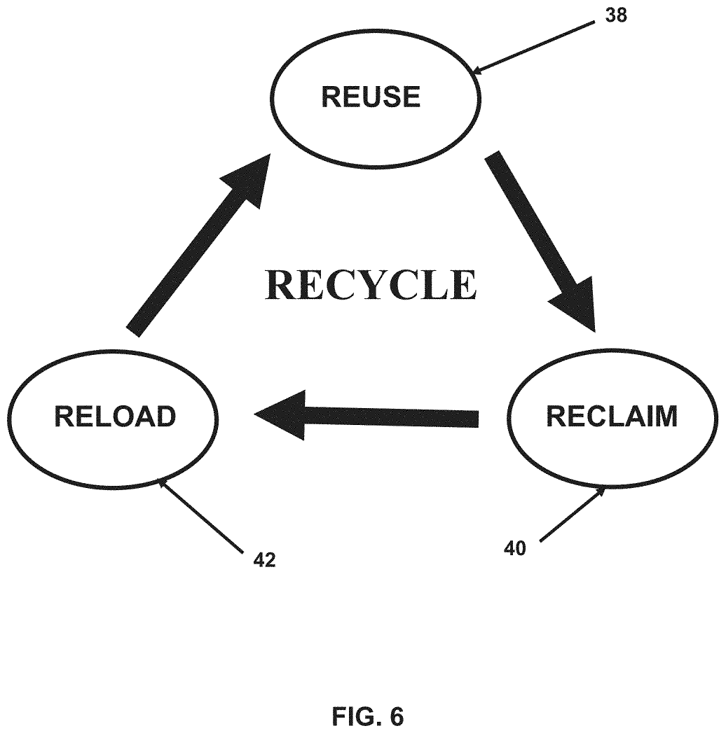

FIG. 5 illustrates a top perspective view of various exemplary presently disclosed components received in an exemplary reusable jar 24 for a jar candle. FIG. 6 is a representative flow chart of one embodiment of exemplary methodology in accordance with presently disclosed subject matter.

The presently disclosed subject matter collectively may comprise technology that allows the same piece of glass/container (for example, jar 24) to be re-used potentially hundreds of times (or more) by a consumer. For example, a consumer may obtain a package or pouch generally 32 of fragranced wax beads or pellets (or other small elements) 34 that may be emptied into jar 24 per representative step 36 (see FIG. 5). In some embodiments, such package may comprise a recyclable paper pouch 32. The amount of wax beads or pellets or shredded materials generally 34 may be matched for use with a particular jar 24 so that the consumer does not have to measure after starting with a completely empty jar. In other instances, such pouch can be comprised of many different configurations (such as a sack or fixed-wall container), and can be made of various materials in addition to paper such as fabric or cardboard. Still other materials might be practiced, such as use of a glass container with lid, or metal (for example, aluminum), or plastics or others.

Representative exemplary pouch (or container) 32 may also include a wick 26 with attached anchor piece 28 or similar (see FIG. 4D) appropriately sized for each fragrance and/or wax formulation, and/or dye color to ensure a clean burn and appropriate length for the corresponding jar 24. Thus, exemplary pouch 32 of representative beads 34 would be intended for a single use with a particular jar 24.

The present disclosure encompasses numerous variations of the foregoing, as will be understood by one of ordinary skill from the complete disclosure herewith. For example, a pouch or container 32 may be sized to hold wax contents which are sufficient for a certain number of jar reuses instead of corresponding to a single jar use. In such case, a corresponding number of wick components could be included with the pouch instead of a single wick component which would typically accompany a pouch if a “single jar” volume of wax components is included. In some instances, wicks and wax components (or mixes thereof) may be entirely separately sourced and/or marketed rather than packaged together.

Per such presently disclosed subject matter, for some embodiments, a consumer could purchase a starter jar and a pouch or container holding wax materials such as beads 34 or materials of other shapes. The starter jar could include the centering disc body 12 (or other device(s)) that would be used for wick centering/positioning and/or generating relative movement between the bottom of the candle container and remaining wax, to facilitate easy removal of the wick end piece and anchor element 28, and for cleaning out the remaining wax residue after the candle has burned all the way down.

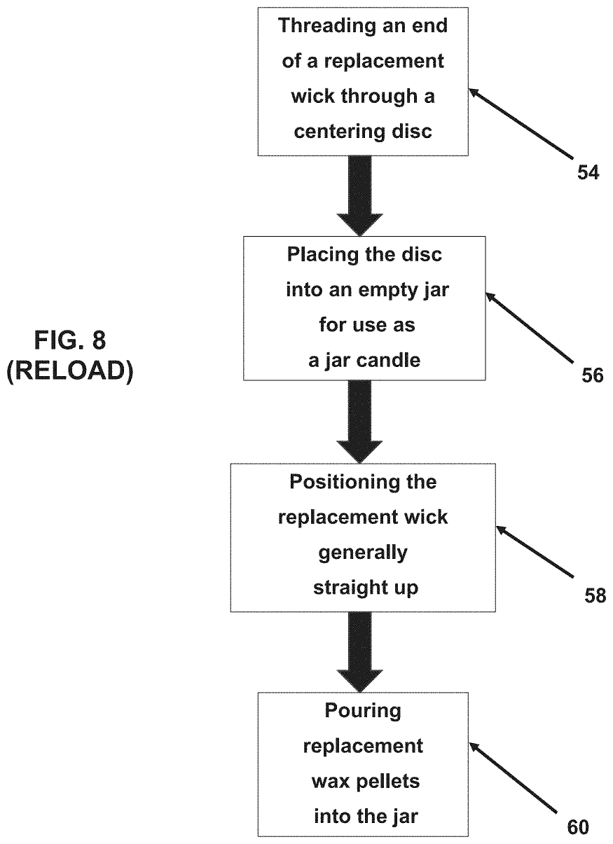

FIG. 6 is a representative flow chart (in continuous form) of one exemplary embodiment of methodology in accordance with presently disclosed subject matter, including a recycle aspect thereof. In particular, a reuse step 38 is followed by a reclaim step 40, and a subsequent reload step 42, all of which collectively (and in order) comprise recycling of the candle. Once a candle is ready for reuse (step 38), a consumer is ready to practice methodology as outlined in FIGS. 7 and 8, for both use of the candle and its readying for reuse after consumption of consumable portions thereof.

FIG. 7 is a representative flow chart (in linear form) of one exemplary embodiment of methodology in accordance with presently disclosed subject matter, including a reclaim aspect (step 40 of FIG. 6) thereof. The flowchart of FIG. 7 recites exemplary steps of one embodiment of presently disclosed subject matter, including: (step 44) using a candle by lighting its wick (or wicks); (step 46) once the candle wick(s) has burned all the way and the flame has extinguished, allow remaining wax to cool and solidify; (step 48) manipulate to generate relative movement between the bottom of the candle container and remaining wax, to facilitate removal of such remaining wax and/or other debris (for example, in some instances, rotate) centering disc to cause remaining wax to break away from jar; (step 50) remove centering disc and wick anchor from jar; and (step 52) clean wax residue and other debris from centering disc. Once the reclaim steps of FIG. 7 are complete, the jar (or other previously used container) is ready to be reloaded with fresh wax and wick (FIG. 8).

Other embodiments of presently disclosed methodology may include alternatives with more or fewer steps and/or different steps. For example, another embodiment may include broadly a step of first ascertaining that consumable aspects of a refillable candle vessel have been sufficiently reduced/depleted that the refillable candle vessel is ready to be reclaimed (or refurbished) per presently disclosed subject matter. For example, such reduction might involve the referenced solidification of a minor amount of remaining wax, or may in some instances involve other removal such as pouring out (in an appropriate and safe manner) any liquid state wax. Thereafter, any remaining wax may partly be dug out or removed from the vessel in some instances with an external tool and/or use of the presently disclosed disc. Also, solidification practices may be varied. For example, in some instances, molten or heated wax elements may be allowed to cool in a room or other surrounding environment, per the temperature etc. conditions prevalent. In other instances, solidification may be accelerated such as by blowing relatively cooler air onto the vessel/container, or by entirely removing the vessel/container from its burn environment into a cooled location, such as a reduced temperature room, or a refrigerator or freezer. In more accelerated conditions (such as involving a refrigerator or freezer), the cooling wax may in some instances actually contract to an extent that it pulls away from the glass or container, so as to be more easily removed from the container.

Still further, some present embodiments may regard the “reuse” aspects disclosed herewith as at least partial burning of the wick and/or consumption of the wax within the jar/container, or several iterations of partial burning of the wick, wherefore such “reuse” may be regarded as separate from the “reclaim” aspects disclosed herewith, or such use or uses may be regarded as part of the “reclaim” process/method.

All such foregoing variations and others to the broadly described steps herewith are intended to come within the spirit and scope of the present disclosure. Once the jar or container is prepped, the disc, wick, and wax elements may be introduced, per other aspects as presently disclosed.

FIG. 8 is a representative flow chart (in linear form) of one exemplary embodiment of methodology in accordance with presently disclosed subject matter, including a reload aspect (step 42 of FIG. 6) thereof. The flowchart of FIG. 8 recites exemplary steps of one embodiment of presently disclosed subject matter, including: (step 54) threading an end of a replacement wick through a centering disc; (step 56) placing the disc into an empty jar for use as a jar candle; (step 58) positioning the replacement wick generally straight up; and (step 60) pouring replacement wax pellets (or other form of materials) into the jar. After that, the refilled sustainable jar candle is ready for the wick to be lit, for use in emitting scent into a selected area or room. In other words, the candle is ready to be reused (step 38 and/or substep 44) as represented in the Figures.

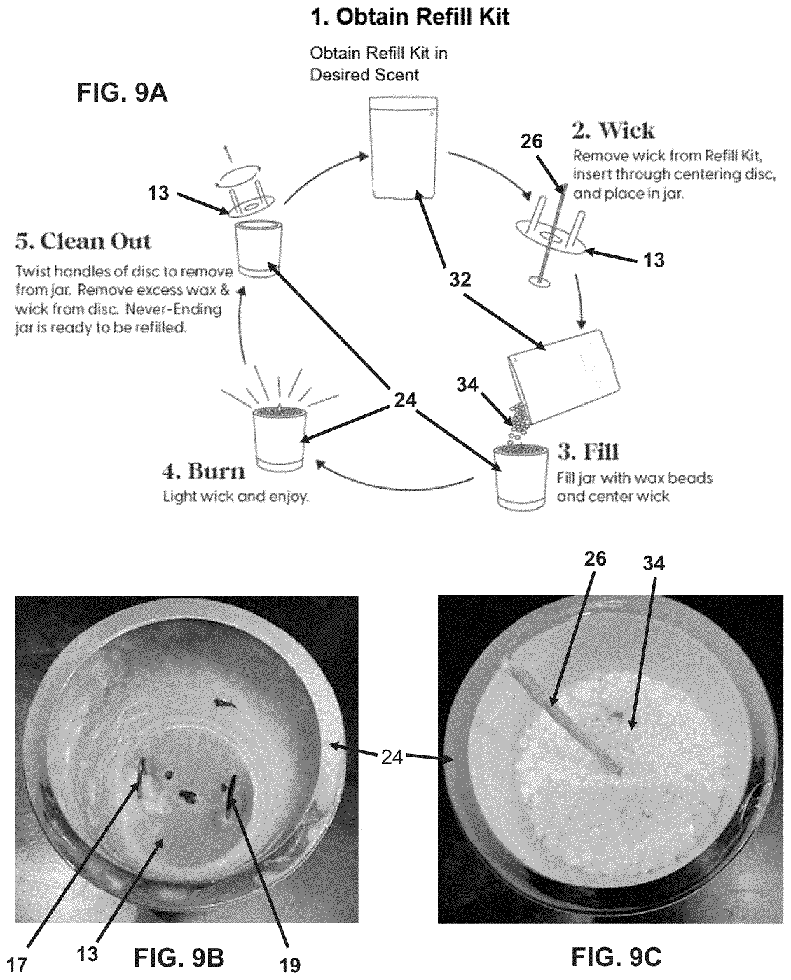

FIG. 9A is another representative flow chart (in continuous/loop form) of an exemplary embodiment of methodology in accordance with presently disclosed subject matter, including exemplary diagrammatic illustrations at various steps thereof, and using the same reference numbers as used in other Figures for same or similar elements or steps. FIG. 9B illustrates a generally top perspective view of an exemplary embodiment of presently disclosed subject matter ready for processing at the “Clean Out” step of application FIG. 9A. FIG. 9C illustrates a generally top perspective view of an exemplary embodiment of presently disclosed subject matter ready for processing at the “Burn” step of application FIG. 9A.

In Step 1 (Obtain Refill Kit) of FIG. 9A, a user obtains a refill kit as presently disclosed, and in a fragrance as and if desired. In some presently disclosed exemplary embodiments, such Step 1 may be fulfilled by obtaining an exemplary pouch 32 as presently disclosed.

In Step 2 of FIG. 9A, the user may remove an exemplary wick 26 from a refill kit, and insert the wick 26 through a centering disc (see body 13 of FIG. 9A) and place the resulting combination into a jar 24. Per Step 3 of FIG. 9A, the user may center the wick 26 in jar 24 and fill jar 24 with wax elements (for example, such as wax beads 34) from pouch 32.

In Step 4 of FIG. 9A, the refilled candle is in the condition represented by application FIG. 9C, and ready to be burned (i.e. used).

After complete use of the reloaded candle (for example, such as after a series of respective burns), Step 5 represents the Clean Out step of the presently disclosed subject matter of FIG. 9A. FIG. 9B represents a jar 24 in such fully used condition as entering Step 5 for Clean Out. The user may twist the handles 17 and 19 of the disc body 13 to generate relative movement between the bottom of the candle container and remaining wax to facilitate removal of such remaining wax and/or other debris from the jar 24. Thereafter, any excess wax and wick (or any other debris) may be removed from the disc body 13 as well as the jar 24. Thereafter, the jar 24 is ready to be refilled further in accordance with presently disclosed subject matter.

As will be understood by those of ordinary skill in the art from the complete disclosure herewith, various controllable factors may influence the sizing and particulars of any given embodiment. For example, the shape of size of a given jar 24 may vary, which would affect correspondingly the shape and size of the disc body 12. Further, such disc body 12 in some embodiments may be flexible and/or bendable so that it can be placed through a jar opening which has a smaller circumference than that of the disc body.

In other instances, other variations regarding the presently disclosed disc technology may be practiced. For example, instead of relying on juxtaposition of the disc size relative to the container size for positioning, an element of the disc technology may be secured (for example, by gluing) to a determined position relative to the container. Thereafter, a wick associated elements, such as an anchor element, could be mechanically joined to the pre-positioned disc, at a prep-positioned point on the disc, so that the result is a properly positioned wick. Such wick anchor element could be secured, for example, by various mating elements which variously engage and disengage such as by relative rotation or twisting of one of the elements rather to the other. Alternatively, an anchor-style element could be a relatively smaller element which is secured to the container, and then the relatively larger disc element is removably secured to the anchor.

Still further, as the size of any jar utilized is varied, a matching pouch of wax pellets may be sized to appropriately fill the jar for a single use (or alternatively for multiple uses). Similarly, the length and other features of the replacement wick may be matched to the jar and the scented wax to be used with the jar. Similarly, wax pellets may be bead shaped or any other readily produced shape, without impact on the overall performance of the jar candle or the technology as presently disclosed. For example, such wax components may comprise flakes, shavings, or other shapes. Advantageously, practice of the presently disclosed technology does not necessarily require of the consumer any interim step involving melting, mixing, pouring or transfer of any type of molten materials such as wax, fragrance, and/or dye. As a result, no heat or heat process is required by the consumer whatsoever for providing a refilled product ready for use.

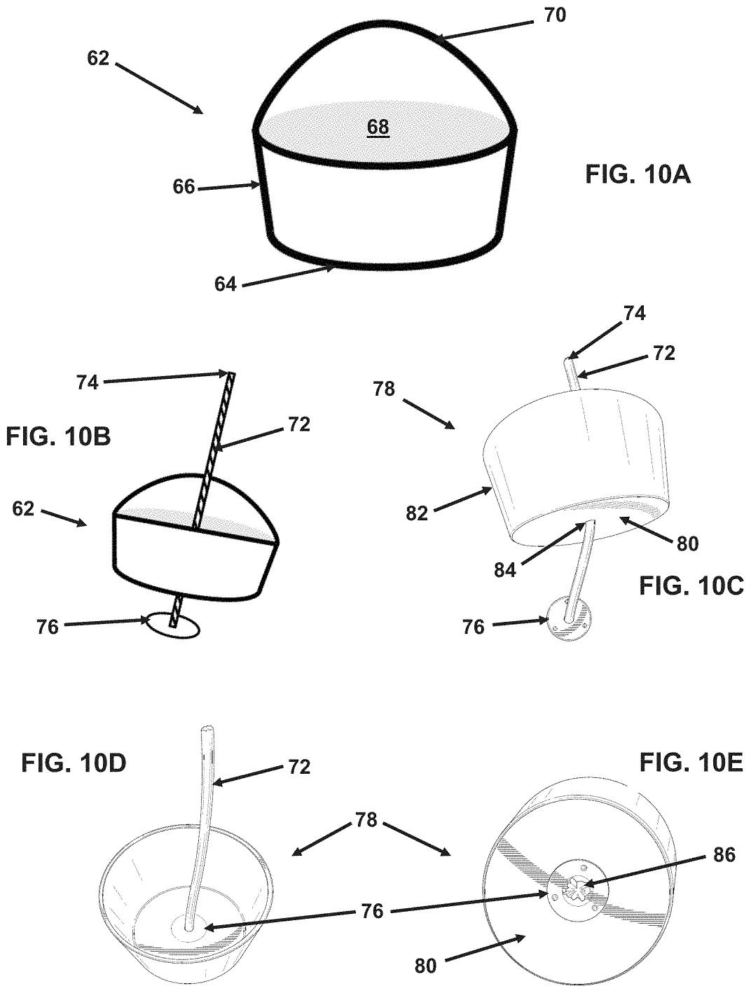

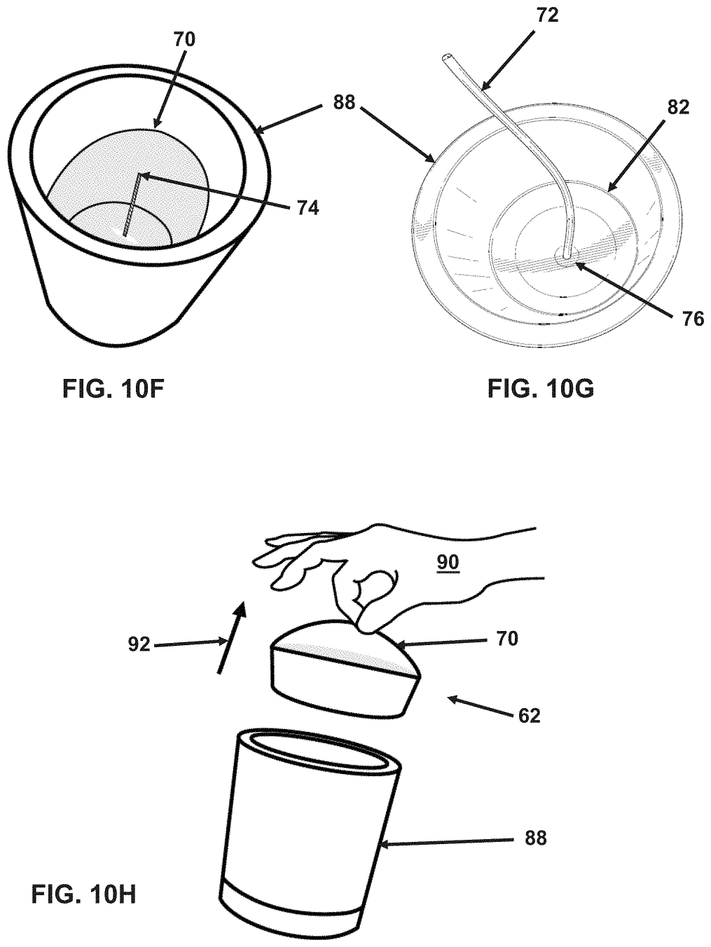

FIGS. 10A through 10H represent further embodiments of presently disclosed subject matter relating in particular to a cleanout tray or insert. In particular, such tray or insert may be formed of silicone or other materials (even including some metals) with similar properties which sufficiently withstand heat from a candle (burning wick) while retaining a preformed structure thereof, and while being at least somewhat flexible to facilitate manipulation of the tray or insert relative to other presently disclosed features. The silicone or similar formed or other like materials are also readily cleanable to remove debris such as any melted and/or unused wax.

FIG. 10A illustrates a generally side and upper perspective view of an exemplary embodiment of a cleanout tray or insert generally 62 of presently disclosed subject matter. Tray or insert 62 comprises a preformed sized and shaped object for receipt in a further receptacle, such as a candle jar or similar. Insert 62 in the illustrated exemplary embodiment may be formed with a bottom generally 64 and sidewalls generally 66, which in turn form a relatively internal region 68 for receipt of materials. As shown, one portion or side 70 of the sidewalls generally 66 may be relatively enlarged and/or extended, to facilitate handling of the insert (particularly for example removal thereof from a candle jar).

FIG. 10B illustrates a generally side and upper perspective view of the exemplary embodiment of a cleanout tray or insert generally 62 of presently disclosed subject matter as shown in FIG. 10A, further combined with presently disclosed replacement wick generally 72 and related features. Though not shown in either of FIG. 10A or 10B, it will be understood to those of ordinary skill in the art from the illustrations and discussions of the present disclosure that an opening or hole may be formed through the bottom 64 of insert 62, for passage of wick 72. In particular, a free end generally 74 of the wick 72 may be threaded through such hole or opening, while the opposite end of wick 72 may be associated with an anchoring device generally 76 or other element to secure the wick 72 from being drawn entirely through the opening or hole in the bottom 64 of insert 62. Anchor 76 may be similar to wick-end anchoring devices or elements otherwise discussed herein, such as metal or ceramic or other heat-resistant materials suitable for the presently-disclosed usages.

FIG. 10C illustrates a generally side and lower perspective view of a further exemplary embodiment of a cleanout tray or insert generally 78 of presently disclosed subject matter. FIG. 10C illustrates insert 78 as also further combined with presently disclosed replacement wick 72 and related features as in present exemplary FIG. 10B. Insert 78 may be formed of similar materials as with insert 62, and also preferably comprise a preformed shape. In this instance, insert 78 also has a bottom generally 80 and sidewalls generally 82. However, such sidewalls 82 in this instance do not form an extended or projecting region, but instead are alternatively relatively even around the entire periphery of the generally rounded (or bucket-shaped) structure 78.

Since the illustration of FIG. 10C is a generally side and lower perspective view, an exemplary opening 84 in bottom 80 is illustrated, and by which a free end 74 of wick 72 may be threaded through the insert 78. Again, a representative anchoring device or element generally 76 is shown as associated with the other end of wick 72, to help ensure that the wick 72 is not entirely drawn through opening 84. It will be understood by those of ordinary skill in the art from the complete disclosure herewith that the exemplary insert 62 of FIG. 10 A and 10B may be provided with a similar opening albeit not visible in those particular figures.

It will be further appreciated from the complete disclosure herewith that the positioning of the opening 84 in the bottom 80 or 64 of an insert in turn influences the positioning of a wick being passed therethrough. In particular, whenever opening 84 is generally centered (or otherwise desirably placed) in either of bottom 80 or 64, the wick is situated so as to be likewise generally centered (or otherwise desirably placed) as replacement wax is placed into an accompanying candle jar, as otherwise explained herein.

FIGS. 10D and 10E illustrate, respectively, a generally top and partial side perspective view, and a generally bottom and partial side perspective view of the further exemplary embodiment of a cleanout tray or insert generally 78 of presently disclosed subject matter as in present exemplary FIG. 10C, and combined with presently disclosed replacement wick 72 and related features as in present exemplary FIG. 10C. Element 76 is illustrated in partial dotted line in FIG. 10D to represent that bottom 80 is illustrated in partial see-through for illustration of the position of element 76. FIG. 10E further represents a knot or end feature generally 86 for securing wick 72 to element 76, as will be understood by those of ordinary skill in the art.

FIGS. 10F and 10G illustrate, respectively, a generally top and side perspective view of the exemplary subject matter of present FIG. 10B, and a generally top and side perspective view of the exemplary subject matter of present FIG. 10C, each further combined with a representative candle jar or container generally 88 receiving the same. It will be understood from the complete disclosure herewith that replacement wax has not been added or introduced into the candle jars 88. Similarly, FIGS. 10F and 10G are not intended to represent that the free end 74 of wick 72 has yet been trimmed as preferred for beginning use of the refilled candle once it is refilled. Anchoring device or element 76 is again partially visible in dotted line in FIG. 10G because the bottom of the insert is shown in partial see-through.

FIG. 10H illustrates generally side and partial top perspective view of the exemplary subject matter (insert 62) of present FIG. 10B, being removed by a user from a representative candle jar or container 88 as illustrated in FIG. 10F. In the exemplary illustration, the hand generally 90 of a user has engaged or grasped extended sidewall section 70 to facilitate lifting in the direction of arrow 92, for removal of insert 62 from candle jar 88. In this instance, the wick (and wax) has been depleted down below view of the sidewalls of insert 62, and the angle of viewing of FIG. 10H does not show the position of element 76 on the bottom of insert 62 as it is withdrawn. Because of the flexible nature of the silicone comprising exemplary subject matter (insert 62), the user can easily turn the insert 62 inside out to simply and easily remove any remaining wax and by grasping anchoring element 76 to pull remaining wick 72 back through opening 84 in bottom 80 of insert 62. It will be appreciated that placement of a refurbished/cleaned insert 62 essentially involves reversal of the direction of arrow 92, so that insert 62 is placed into candle jar 88 rather than removed. FIG. 5 represents a refilled candle jar, with the replacement wax covering either of an anchoring/centering/positioning device or an insert or other structure(s) used in accordance with the present disclosure, and with the replacement wick partially covered by the replacement wax, as will be understood by those of ordinary skill in the art from the complete disclosure herewith.

All of the foregoing variations of specific practices and/or variations on embodiments, whether discussed or suggested, are intended to come within the spirit and scope of the presently disclosed subject matter.

Throughout, repeat use of the same reference numbers as in other figures is intended to represent similar or same features, with pertinent discussion applicable thereto.

While the presently disclosed subject matter has been described in detail with respect to specific exemplary and representative embodiments thereof, it will be appreciated that those skilled in the art, upon attaining an understanding of the foregoing, may readily produce alterations to, variations of, and/or equivalents to such embodiments. Accordingly, the scope of the present disclosure is by way of example rather than by way of limitation, and the subject disclosure does not preclude inclusion of such modifications, variations, and/or additions to the presently disclosed subject matter as would be readily apparent to one of ordinary skill in the art.

What is claimed is:

1. Methodology for providing sustainable candles by refurbishing a used candle container for reuse thereof, comprising:
cleaning out a used candle container to remove any debris therein;
associating one end of a replacement wick with an anchoring component associated with the candle container;
directing an unassociated free end of the replacement wick into a generally upward position relatively away from walls of the used candle container; and
placing replacement wax elements into the used candle container, whereby any remaining prior wick and wax components in the used candle container are exchanged for replacement wick and wax components, so that the used candle container can be reused instead of being thrown out.

2. Methodology as in claim 1, wherein the anchoring component comprises a centering indentation formed in the bottom of the candle container.

3. Methodology as in claim 1, wherein:
the anchoring component comprises a centering disc removably received in said candle container; and
the methodology further comprises placing the centering disc into the cleaned out used candle container.

4. Methodology as in claim 1, wherein said used candle container comprises a candle jar.

5. Methodology as in claim 3, wherein the one end of the replacement wick is threaded through the centering disc.

6. Methodology as in claim 5, wherein the centering disc comprises a metal disc.

7. Methodology as in claim 6, wherein the replacement wax elements comprise one of scented and unscented wax elements poured into the candle jar, and which hold the replacement wick in a generally straight up position once poured into the candle jar.

8. Methodology as in claim 7, wherein:
the wax pellets are scented; and
said methodology further includes selectively lighting the replacement wick so as the wick is burned down towards the upper surface of the wax pellets, the wax pellets are melted to release scent.

9. Methodology as in claim 8, further including the step of, once the prior replacement wick is substantially burned down and the replacement wax elements are substantially melted and consumed, removing and cleaning the centering metal disc for reuse with a new replacement wick.

10. Methodology as in claim 9, further including:
reloading the cleaned centering metal disc with a new replacement wick;
replacing the centering disc into the candle jar; and
refilling the candle jar with new replacement wax pellets while the new replacement wick is held in a generally upright position.

11. Methodology as in claim 7, wherein the wax elements comprise at least one of wax beads, pellets, flakes, chunks, or other shaped objects, and combinations thereof.

12. Methodology as in claim 11, wherein the wax elements are packaged in a pouch and prefilled with an amount appropriately sized for a corresponding preexisting jar.

13. Methodology as in claim 12, wherein the pouch comprises a recyclable and/or compostable paper pouch.

14. Methodology as in claim 12, wherein the pouch further includes a replacement wick.

15. Methodology as in claim 12, wherein the amount of wax elements and the size and prefilling of the pouch corresponds with an amount to serve one of multiple reuses of a given jar and a plurality of preexisting jars.

16. Methodology as in claim 3, wherein the centering disc has a main body having a central through-hole for receiving the one end of the replacement wick, and having at least one handle for manipulation of the centering disc by a user.

17. Methodology as in claim 16, wherein the one end of the replacement wick has a stop member attached thereto, and larger than the through-hole, for engaging the replacement wick with the centering disc by preventing the wick from pulling through the through-hole once threaded into place.

18. Methodology as in claim 16, wherein the main body of the centering disc has a pair of handles on respective generally opposite sides of said through-hole.

19. Methodology as in claim 3, wherein the methodology includes providing a plurality of replacement wicks for simultaneous use with a centering disc, and the centering disc has a main body having a respective plurality of central through-holes corresponding to the plurality of replacement wick for respective use therewith, so that the resulting sustainable candle has a plurality of wicks.

20. Methodology as in claim 16, wherein the centering disc main body is sized and shaped to match the size and shape of the bottom of an associated used candle container with which the centering disc is used.

21. Methodology as in claim 16, wherein cleaning out a used candle container at least includes removing the centering disc from the used candle container.

22. Methodology as in claim 16, wherein the centering disc main body comprises heat and fire resistant materials, including at least one of metal, ceramics, plastics, and alloys.

23. Methodology as in claim 1, wherein:
the candle container comprises one of glass, ceramics, and metal materials, and is shaped with sidewalls which are at least one of even, tapered larger towards a candle container top opening, or tapered smaller towards the candle container top opening; and
cleaning out a used candle container to remove any debris therein includes creating relative movement between the debris and the bottom of the candle container.

24. Methodology as in claim 3, wherein:
the centering disc has a main body having a central through-hole for receiving the one end of the replacement wick;
the main body has a circumference larger than the mouth of the candle container; and
the centering disc main body is flexible to be placed through the mouth of the candle container.

25. Method for using refillable candle jars for refurbishing a used candle jar so that its depleted wick and wax components are exchanged for replacement wick and wax, so that the candle jar can be reused instead of being discarded, comprising:
fitting a cleaned out candle jar with a replacement wick and wax beads by threading an end of the wick through an anchor component, and then placing the anchor component into the empty jar; and
holding the replacement wick physically straight up while introducing replacement wax beads into the jar so that the beads continue to hold the wick in a designated position.

26. Method as in claim 25, wherein said method includes first cleaning out a used candle jar to remove any remaining materials therein.

27. Method as in claim 25, wherein the replacement wax beads comprise scented wax beads, and the method further includes burning the replacement wick in order to melt scented wax beads as the wick burns down, for releasing scent into the environment in which the candle is used.

28. Method as in claim 25, wherein said anchor component comprises a centering metal disc.

29. Method as in claim 28, wherein said designated position comprises a relatively centered position in said jar.

30. Method as in claim 29, further including:
removing the centering disc from the jar once the wick is substantially burned down; and
removing any remaining wax or debris from the jar.

31. Method as in claim 30, further including cleaning the removed centering disc and reattaching a new replacement wick to the disc.

32. Method as in claim 31, reloading the cleaned out candle jar with a cleaned centering disc and new replacement wick and new replacement wax beads, and wherein the replacement wax beads comprise scented wax beads.

33. A sustainable candle, comprising:
a candle container which is cleanable after use thereof to remove any debris therein;
an anchoring component associated with said candle container;
an elongated replacement wick having an anchor end thereof secured to said anchoring component, and having an unassociated free end thereof, positioned generally above said anchor end, for being selectively lighted for burning the replacement wick; and
replacement wax elements received in said candle container while said wick anchor end is secured to said anchoring component, whereby replacement wick and wax elements may be received in a used candle container once cleaned.

34. A sustainable candle as in claim 33, wherein said used candle container comprises one of glass, ceramics, and metal materials.

35. A sustainable candle as in claim 33, wherein said anchoring component comprises a centering indentation formed in the bottom of the candle container.

36. A sustainable candle as in claim 33, wherein said anchoring component comprises a centering disc removably received in said candle container.

37. A sustainable candle as in claim 36, wherein the centering disc has a main body comprising heat and fire resistant materials, including at least one of metal, ceramics, plastics, and alloys, and said main body has a central through-hole for receiving said anchor end of said replacement wick.

38. A sustainable candle as in claim 33, wherein the replacement wax elements comprise one of scented and unscented wax elements received in said candle container, and which hold the replacement wick in a generally straight up position.

39. A sustainable candle as in claim 38, wherein the wax elements are scented and comprise at least one of wax beads, pellets, flakes, chunks, or other shaped objects, and combinations thereof.

40. A sustainable candle as in claim 33, further comprising a plurality of said wax elements prepackaged in a pouch prefilled with an amount appropriately sized for a corresponding preexisting candle container.

41. A sustainable candle as in claim 33, wherein the centering disc has a metal main body having a central through-hole for receiving said anchor end of said replacement wick, and having at least one handle for manipulation of the centering disc by a user.

42. A sustainable candle as in claim 41, wherein said main body of said centering disc has a pair of handles on respective generally opposite sides of said through-hole.

43. A sustainable candle as in claim 33, wherein the centering disc has a main body sized and shaped to match the size and shape of the bottom of an associated candle container with which the centering disc is used.

44. A sustainable candle as in claim 33, wherein:
the centering disc has a main body having a central through-hole for receiving said anchor end of said replacement wick;
said main body has a circumference larger than the mouth of an associated candle container with which the centering disc is used; and
the centering disc main body is flexible to be placed through the mouth of the candle container.

45. A sustainable candle kit for use with a reusable candle container, comprising:
an elongated replacement wick having a first end thereof and having an unassociated free second end thereof for being selectively lighted for burning the replacement wick; and
at least one replacement wax element receivable in said candle container while said wick first end is received in said at least one replacement wax element, whereby replacement wick and wax elements are refillable with the cleaned previously used candle container so that the candle container can be reused instead of being thrown out.

46. A sustainable candle kit as in claim 45, wherein the used candle container comprises one of glass, ceramics, metal, and/or other materials which is cleanable after use thereof to remove any debris therein.

47. A sustainable candle kit as in claim 45, further comprising an anchoring component removably receivable in a cleaned previously used candle container, and the elongated replacement wick first end comprises an anchor end thereof securable to said anchoring component, and with the replacement wax elements receivable in said candle container while said wick anchor end is secured to said anchoring component.

48. A sustainable candle kit as in claim 47, wherein the anchoring component comprises a centering disc which has a main body comprising heat and fire resistant materials, including at least one of metal, ceramics, plastics, and alloys, and said main body has a central through-hole for receiving said anchor end of said replacement wick.

49. A sustainable candle kit as in claim 45, wherein the at least one replacement wax element comprises a plurality of one of scented and unscented wax elements received in said candle container, and which hold the replacement wick in a generally straight up position.

50. A sustainable candle kit as in claim 49, wherein the wax elements are scented and comprise at least one of wax beads, pellets, flakes, chunks, or other shaped objects, and combinations thereof.

51. A sustainable candle kit as in claim 45, further comprising a plurality of said wax elements prepackaged in a pouch prefilled with an amount appropriately sized for a corresponding preexisting candle container.

52. A sustainable candle kit as in claim 51, wherein said replacement wick is prepackaged with said pouch.

53. A sustainable candle kit as in claim 48, wherein the centering disc has a metal main body having at least one handle for manipulation of the centering disc by a user.

54. A sustainable candle kit as in claim 53, wherein said main body of said centering disc has a pair of handles on respective generally opposite sides of said through-hole.

55. A sustainable candle kit as in claim 48, wherein the centering disc has a main body sized and shaped to match the size and shape of the bottom of an associated candle container with which the centering disc is used.

56. A sustainable candle kit as in claim 48, wherein:
said main body has a circumference larger than the mouth of an associated candle container with which the centering disc is used; and
the centering disc main body is flexible to be placed through the mouth of the candle container.

57. Methodology for providing sustainable candles by refurbishing a used candle container for reuse thereof, comprising:
cleaning out a used candle container to remove any debris therein by creating relative movement between the debris and the bottom of the candle container.
associating a replacement wick with a heat-resistant insert associated with the candle container;
directing an unassociated free end of the replacement wick into a generally upward position relatively away from walls of the used candle container; and
placing replacement wax elements into the used candle container, whereby any remaining prior wick and wax components in the used candle container are exchanged for replacement wick and wax components, so that the used candle container can be reused instead of being thrown out.

58. Methodology as in claim 57, wherein associating a replacement wick with a heat-resistant insert associated with the candle container includes threading an end of the wick through a heat-resistant insert, and then placing the insert into the bottom of the candle container; and

59. Methodology as in claim 58, wherein the heat-resistant insert comprises one of a centering disc or a premolded tray removably received in the bottom of the candle container.

60. Methodology as in claim 59, wherein the premolded tray comprises a silicone-based removable tray premolded to match and rest in the bottom of the candle container.

61. Methodology as in claim 60, wherein the removable tray includes at least one extended sidewall portion thereof to facilitate removal and placement by a user of the tray relative to the candle container.

62. Methodology as in claim 57, wherein:
said used candle container comprises a candle jar; and
the replacement wax elements comprise one of scented and unscented wax elements poured into the candle jar, and which hold the replacement wick in a generally straight up position once poured into the candle jar.

63. Methodology as in claim 62, wherein:
the wax elements are scented; and
said methodology further includes selectively lighting the replacement wick so as the wick is burned down towards the upper surface of the wax elements, the wax elements are melted to release scent.

64. Methodology as in claim 63, further including the step of, once the prior replacement wick is substantially burned down and the replacement wax elements are substantially melted, removing and cleaning the insert for reuse with a new replacement wick.

65. Methodology as in claim 64, further including:
reloading the cleaned insert with a new replacement wick;
replacing the insert into the candle jar; and
refilling the candle jar with new replacement wax pellets while the new replacement wick is held in a generally upright position.

66. Methodology as in claim 62, wherein the wax elements comprise at least one of wax beads, pellets, flakes, chunks, or other shaped objects, and combinations thereof.

67. Methodology as in claim 57, wherein the insert has at least one through-hole for receiving an end of the replacement wick, and has at least one handle for manipulation of the insert by a user.

68. Methodology as in claim 57, wherein:
the insert has at least one through-hole for receiving an end of the replacement wick;
the insert has a circumference larger than the mouth of the candle container; and
the insert is flexible to be placed through the mouth of the candle container.
